(19) United States
(12) Patent Application Publication
(10) Pub. No.: US 2020/0040283 A1
(43) Pub. Date: Feb. 6, 2020

(54) DELAYED RELEASE ENZYME FORMULATIONS FOR BLEACH-CONTAINING DETERGENTS

(71) Applicant: Danisco US Inc, Palo Alto, CA (US)

(72) Inventors: Amanda Jane Kalogrides, Campbell, CA (US); Christopher James Angeles, Milpitas, CA (US); Nathaniel T. Becker, Palo Alto, CA (US); Katherine D. Collier, Loomis, CA (US); Victoria Huang, Palo Alto, CA (US); Peyman Moslemy, Palo Alto, CA (US); Luther White, Palo Alto, CA (US); Jeffrey Chen, Cerritos, CA (US)

(21) Appl. No.: 16/499,642

(22) PCT Filed: Mar. 29, 2018
(86) PCT No.: PCT/US2018/025120

§ 371 Date: Sep. 30, 2019

Related U.S. Application Data
(60) Provisional application No. 62/480,122, filed on Mar. 31, 2017.

(51) Int. Cl. C11D 3/386; C11D 3/39; C11D 3/395; C11D 11/00

(52) U.S. Cl. CPC C11D 3/38672; C11D 3/38618; C12Y 304/21062; C11D 3/395; C11D 11/0017; C11D 3/39

(57) ABSTRACT

Described are compositions and methods relating to delayed release enzyme formulations for bleach-containing detergents, and methods of use, thereof. The formulations are designed to promote the rapid release of a bleaching agent into a wash liquor and the delayed release of a protease, to reduce the undesirable effect that high concentrations of bleach have on protease activity. The compositions and methods have applications in, e.g., laundry and dishwashing.

### PRIORITY

The present application claims the benefit of U.S. Provisional Application Ser. No. 62/480,122, filed Mar. 31, 2017, which is hereby incorporated by reference in its entirety.

### TECHNICAL FIELD

The present compositions and methods relate to delayed-release enzyme formulations for bleach-containing detergents, and methods of use, thereof. The compositions and methods have applications in laundry, dishwashing, and other cleaning applications.

### BACKGROUND

Enzymes are desirable components in laundry and dishwashing detergents and other cleaning compositions as they provide cleaning benefits on a variety of stains. Proteases are the most important enzymes present in commercial detergent compositions and are effective in removing proteinaceous stains, including those relating to blood, dairy products, egg, baby food, body soils, and the like.

Oxidative bleaches are another desirable component of cleaning compositions and are effective for removing, or at least reducing the appearance of, pigment-containing stains that include colorants, e.g., chlorophylls, carotenoid pigments, tannins, anthocyanin dyes, humic acids, and the like. Most bleaches in laundry and dishwashing detergents are oxidizers, such as sodium perborate or percarbonate, which give rise to hydrogen peroxide, or sodium hypochlorite. In addition, cleaning compositions frequently include bleach activators, which enhance the effectiveness of the bleaching agent by producing perhydrogen compounds. A common bleach enhancer is tetraacetylethylenediamine (TAED).

Since proteases are enzymes that normally work under physiological conditions, it is not surprising that highly oxidative environments, such as those that exist in a detergent cleaning composition with an oxidizing bleaching agent, can lead to inactivation. The need exists for laundry detergent formulations that maximize oxidative bleaching as well a protease activity during the wash cycle.

### BRIEF SUMMARY OF THE INVENTION

The present compositions and methods relate to delayed-release enzyme formulations for bleach-containing detergents, and methods of use, thereof. Aspects and embodiments of the compositions and methods are described in the following numbered paragraphs.

1. In one aspect, a cleaning composition for removing proteinaceous stains from surfaces in the presence of a bleaching agent is provided, comprising:

a first sub-composition comprising a bleaching agent and being capable of rapid dissolution in a wash liquor; and

a second sub-composition comprising a protease and having a slower rate of dissolution in the wash liquor compared to the first sub-composition comprising the bleaching agent;

wherein upon dilution in a wash liquor at a preselected temperature, the majority of the bleaching agent is released into the wash liquor before the majority of the protease is released into the wash liquor.

2. In some embodiments of cleaning composition of paragraph 1, less than about 50% of the protease is released into the wash liquor until a bleaching reaction between the bleaching agent and proteinaceous stains is complete.

3. In some embodiments of cleaning composition of paragraph 1 or 2, at least 80% of the bleaching agent is released into the wash liquor in less than about one minute before no more than about 50% of the protease is released into the wash liquor in less than about one minute, as measured at a pre-selected temperature.

4. In some embodiments of cleaning composition of paragraph 3, the preselected temperature is 32° C.

5. In some embodiments of cleaning composition of paragraph 3, the preselected temperature is 16° C.

6. In some embodiments of cleaning composition of any of the previous paragraphs, the cleaning composition is a laundry detergent.

7. In some embodiments of cleaning composition of any of the previous paragraphs, wherein the surface having the proteinaceous stains to be cleaned is a fabric.

8. In some embodiments of cleaning composition of any of the previous paragraphs, wherein the protease is a subtilisin protease.

9. In another aspect, a method of cleaning proteinaceous stains in the presence of a bleaching agent is provided, the method comprising:

providing a cleaning composition comprising:

a first sub-composition comprising a bleaching agent and being capable of rapid dissolution in a wash liquor; and

a second sub-composition comprising a protease and having a slower rate of dissolution in the wash liquor compared to the sub-composition comprising the bleaching agent;

adding the cleaning composition to a wash liquor in contact with an article having a proteinaceous stain to clean the proteinaceous stain; and

incubating the article having a proteinaceous stain with the cleaning composition in the wash liquor for a time sufficient to affect the dissolution of the first and second sub-compositions;

wherein the cleaning of the proteinaceous stains is improved compared to providing the bleaching agent and the protease in the same sub-composition.

10. In some embodiments of the method of paragraph 9, less than about 50% of the protease is released into the wash liquor until a bleaching reaction between the bleaching agent and proteinaceous stains is complete.

11. In some embodiments of the method of paragraph 9 or 10, at least 80% of the bleaching agent is released into the wash liquor in less than about one minute before no more than about 50% of the protease is released into the wash liquor in less than about one minute, as measured at a pre-selected temperature.

12. In some embodiments of the method of paragraph 11, the preselected temperature is 32° C.

13. In some embodiments of the method of paragraph 11, the preselected temperature is 16° C.

14. In some embodiments of the method of any of paragraphs 9-13, the cleaning composition is a laundry detergent.

15. In some embodiments of the method of any of paragraphs 9-14, the surface having the proteinaceous stains to be cleaned is a fabric.

16. In some embodiments of the method of any of paragraphs 9-15, the protease is a subtilisin protease.

17. In another aspect, a method for reducing the amount of protease enzyme required to at least partially remove proteinaceous stains from fabric in the presence of a bleaching agent is provided, the method comprising providing the protease in a first composition having a slower rate of dissolution in the wash liquor compared to a second composition comprising the bleaching agent, wherein the cleaning of the proteinaceous stains is improved compared to providing the bleaching agent and the protease in the same composition.

18. In some embodiments of the method of paragraph 17, less than about 50% of the protease is released into the wash liquor until a reaction between the bleaching agent and proteinaceous stains is complete.

19. In some embodiments of the method of paragraph 17 or 18, at least 80% of the bleaching agent is released into the wash liquor in less than about one minute before no more than about 50% of the protease is released into the wash liquor in less than about one minute, as measured at a pre-selected temperature.

20. In some embodiments of the method of paragraph 19, the preselected temperature is 32° C.

21. In some embodiments of the method of paragraph 19, the preselected temperature is 16° C.

22. In some embodiments of the method of any of paragraphs 17-21, the composition is a laundry detergent.

23. In some embodiments of the method of any of paragraphs 17-22, the protease is a subtilisin protease.

24. In some embodiments of the method of any of paragraphs 17-23, the reduction in the amount of protease enzyme required to at least partially remove proteinaceous stains from the fabric is at least 25%.

These and other aspects and embodiments of the compositions and methods are described, below.

### BRIEF DESCRIPTION OF THE DRAWINGS

FIG. 1 is a graph showing the effect of delaying protease addition to a wash liquor containing a standard amount of an industry-benchmark, bleach-containing wash composition.

FIG. 2 is a graph showing the enzyme release profiles of exemplary delayed-release enzyme formulations.

FIG. 3 is a graph showing the cleaning performance of exemplary delayed-release enzyme formulations on fabric swatches stained with “blood, milk, ink” in a bleach-free detergent wash liquor.

FIG. 4 is a graph showing the cleaning performance of exemplary delayed-release enzyme formulations on fabric swatches stained with “blood, milk, ink” in a bleach-containing detergent wash liquor.

### DETAILED DESCRIPTION

### I. Introduction

The present compositions and methods relate to delayed-release enzyme formulations for bleach-containing detergents, and methods of use, thereof. The delayed-release enzyme formulations are designed to delay the release of protease enzymes into a wash liquor until the level of active oxygen or bleach components is diminished, thereby reducing the unwanted effects of bleaching agents on protease cleaning performance and improving protein stain removal.

Loss of protease cleaning performance in detergent formulations containing oxidizing bleach components is known to occur by oxidation of the enzyme, although some proteases are tolerant to a considerable degree of oxidation prior to losing activity. One conventional solution is to make the proteases more oxidatively stable, typically by way of a protein engineering approach to remove oxidizable residues, such as methionines. Since conventional bleaches and bleaching systems are rapidly soluble in the wash and exert most of their bleaching effect within the first 1-3 minutes of the wash cycle, another proposed solution has been to delay the release of oxidizing bleach components, by encapsulating the bleach components or sequestering them in pouches, until the protease has had a chance to digest proteinaceous stains, as suggested by, e.g., Becker et al. (1997) “Formulation of Detergent Enzymes” (Ch. 15) in Enzymes in Detergency, van Ee, J. H et al. (Eds.) Marcel Dekker, Inc. New York. pp. 299-325, and in U.S. Pat. No. 4,391,723 (Bacon et al.) and U.S. Pat. No. 4,473,507 (Bossu) filed by the Procter & Gamble Company.

In contrast, the present compositions and methods are based on a new understanding of how oxidative bleaching agents interfere with protease performance, which leads to a very different solution. It has now been observed that high concentrations of oxidizing bleach cause proteases to become bound to surfaces to be cleaned, particularly soiled fabrics, likely by oxidative cross-linking. Not only does the cross-linking of protease to a surface to be cleaned prevent the enzyme from diffusing in wash liquor and cleaning stains, it also burdens the article to be cleaned with unwanted polypeptides, at least some of which are likely to remain attached to the article after cleaning. Such polypeptides may subsequently cause the article to attract dirt and microorganisms more rapidly than normal, diminish the appearance or feel of cleanliness, and even causing malodor.

The present compositions and methods are based on the delayed release of proteases until the level of oxidizing bleach components is reduced in the wash liquor, thereby allowing the bleaching agent to attack stains at full potency without cross-linking proteases to the article to be cleaned, and then allowing the protease to function at full potency once the level of oxidizing bleach components is reduced. As a result of this delayed-release profile, greater cleaning efficiency is achieved using the same level of proteases. Alternatively, or additionally, the amount of proteases required to achieve a preselected level of cleaning performance can be substantially reduced, e.g. as much as 50% or greater, thereby reducing the cost of manufacturing detergent bleach compositions and reducing worker and consumer exposure to immunogenic enzymes.

The described delayed release profile can be achieved by using a variety of different formulation designs, including those involving matrix compositions and coated particles. In general, the present compositions and methods require at least two different formulation components, which can be regarded as “sub-formulations,” namely (i) a fast-release sub-formulation comprising a bleaching agent and (ii) a delayed-release sub-formulation comprising proteases. These sub-formulations are ideally present together in a single detergent formulation for consumer or industrial use, although they could, in theory, be provided separately, e.g., as a two-part detergent formulation.

Details and embodiments of the compositions and methods are provided, below.

### II. Definitions

Prior to further describing the compositions and methods, the following terms are defined. Unless defined otherwise herein, all technical and scientific terms used herein have the same meaning as commonly understood by one of ordinary skill in the art to which this invention pertains. Although any methods and materials similar or equivalent to those described herein find use in the practice of the present invention, the preferred methods and materials are described herein. Accordingly, the terms defined immediately below are more fully described by reference to the Specification as a whole. Also, as used herein, the singular terms “a,” “an,” and “the” include the plural reference unless the context clearly indicates otherwise. It is to be understood that this invention is not limited to the particular methodology, protocols, and reagents described, as these may vary, depending upon the context they are used by those of skill in the art.

It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

As used herein, an “aqueous medium” or “aqueous solution” is a solution and/or suspension in which the solvent is primarily water (i.e., the solvent is at least 50% water, at least 60% water, at least 70% water, at least 80% water, or even at least 90% water). The aqueous medium may include any number of dissolved or suspended components, including but not limited to surfactants, salts, buffers, stabilizers, complexing agents, chelating agents, builders, metal ions, additional enzymes and substrates, and the like. Exemplary aqueous media are laundry and dishwashing wash liquors. Materials such as textiles, fabrics, dishes, kitchenware, and other materials may also be present in or in contact with the aqueous medium.

As used herein, a “bleaching agent” is a molecule capable of oxidizing chromophores present in stains and soils. Examples of bleaching agents include but are not limited to hypochlorites, peroxides, and nitrates. The most common bleaching agents are chlorine- or peroxide-based. The most common chlorine-based bleaching agents are sodium and calcium hypochlorite, chlorine, and chlorine dioxide. The most common peroxide-based bleaching agents are hydrogen peroxide and sodium and potassium salts of percarbonate and perborate, which may be used in combination with a peracid-forming bleach activator such as tetraacetylethylenediamine (TAED) or nonanoyloxybenzenesulfonate (NOBS).

Alternatively, the bleaching system may comprise peroxyacids (e.g., the amide, imide, or sulfone type peroxyacids). The bleaching system can also be an enzymatic bleaching system, for example, perhydrolase, such as that described in International PCT Application WO 2005/056783.

As used herein, the term “bleaching” refers to the treatment of a material (e.g., fabric, laundry, dishes, pulp, etc.) for a sufficient length of time and under appropriate pH and temperature conditions to effect a brightening (i.e., whitening) and/or cleaning of the material. The “bleaching reaction” between a bleaching agent and, e.g., a proteinaceous stain,” occurs rapidly (e.g., within about a minute) upon introduction of a conventional bleaching-laundry detergent composition (with a fast-release bleach formulation) to a wash solution containing soiled fabrics.

As used herein, the terms “detergent composition” and “detergent formulation” are used in reference to mixtures which are intended for use in a wash medium for the cleaning of soiled objects. In some preferred embodiments, the term is used in reference to laundering fabrics and/or garments (e.g., “laundry detergents”). In alternative embodiments, the term refers to other detergents, such as those used to clean dishes, cutlery, etc. (e.g., “dishwashing detergents”).

As used herein the term “hard surface cleaning composition” refers to detergent compositions for cleaning hard surfaces such as floors, walls, tile, bath and kitchen fixtures, and the like.

A “suspension” or “dispersion” as used herein refers to a two-phase system wherein a discontinuous solid phase is dispersed within a continuous liquid phase.

As used herein, a “cleaning composition” is a formulated, consumer-ready product suitable for use in cleaning stains and soils from clothing, dishware, and other surfaces.

Cleaning compositions are generally provided to consumers in concentrated form, which are diluted with water at least 10-fold weight/weight (wt/wt) when put into use.

As used herein, a “wash liquor” is an aqueous medium containing a diluted cleaning composition.

As used herein, “ballast” refers to objects to be cleaned present in a wash liquor. Examples of ballast are clothes, fabric swatches, and the like.

As used herein, “essentially complete release” refers to at least 90% release, at least 95% release, and preferably at least 97% release of an active agent (such as a bleaching agent or an enzyme).

As used herein, “a rapid rate of dissolution, “rapid release,” “fast release” and similar terms refers to essentially complete release of an active agent (such as a bleaching agent or an enzyme) within three minutes following dissolution in a wash liquor at a specified, pre-selected temperature. Sub-formulations capable of rapid release may be referred to as “fast-release components,” and can be included in a consumer-ready detergent composition.

As used herein, a “slow rate of dissolution,” “slow release,” “delayed release” and similar terms refers to no more than about 50% release of an active agent (such as a bleaching agent or an enzyme) in less than about one minute as measured at a specified, pre-selected temperature. Preferably, at least about 80% of the active agent is released into the wash liquor in less than about three minutes as measured at the specified, pre-selected temperature. Sub-formulations capable of rapid release may be referred to as “delayed-release components” or “slow-release components,” and can be included in a consumer-ready detergent composition.

As used herein, a “majority” is any amount greater than 50% of a whole.

As used herein, a “proteinaceous stain” is a stain or soil containing protein.

### III. Embodiments of Delayed Release Enzyme Formulations

As described, above, the present compositions and methods relate to delayed-release enzyme formulations for bleach-containing detergents, and methods of use, thereof. Delayed release can be achieved using variety of different formulation designs but essential to the compositions and methods is a fast-release component, herein referred to as a fast-release sub-formulation, comprising a bleaching agent and a delayed-release component, also referred to as a slow release sub-formulation, comprising proteases. As a practical matter, these sub-formulations are present together in a single detergent formulation, or a single unit dose detergent formulation, for consumer or industrial use. Examples of such formulations are described in more detail, below.

A. Fast-Release Sub-Formulation

The fast-release sub-formulation includes a bleaching agent (including the components of a bleaching system) capable of rapid dissolution in a wash liquor; wherein the majority of the bleaching agent is released into the wash liquor before the majority of protease (including multiple proteases) is released into the wash liquor.

In some embodiments, a reaction between the bleaching agent and proteinaceous stains is complete before less than about 50% of the protease is released into the wash liquor.

In some embodiments, at least 80% of the bleaching agent is released into the wash liquor in less than about one minute before no more than about 50% of the protease is released into the wash liquor in less than about one minute, as measured at a specified, pre-selected temperature, for example 16 or 32° C.

In some embodiments, the present compositions and methods allow the use of a reduced amount of protease in a detergent composition to achieve the same cleaning benefit. In particular embodiments, the reduction is at least 25%, at least 30%, at least 35%, at least 40%, at least 45%, or even at least 50%. In some embodiments, the reduction in the amount of protease allows a detergent manufacturer to include additional amounts of other enzymes, or even include a different protease having a different immunological profile.

The fast-release sub-formulation includes one or more oxidative bleaching agents, and optionally associated components, including but not limited to hydrogen peroxide, sources of hydrogen peroxide, such as percarbonate salts, bleach activators and boosters, such as tetraacetylethylenediamine (TAED) and sodium nonanoyloxybenzenesulfonate (NOBS), bleach boosters, preformed peracids, enzymatically produced peracids, hypochlorite, and other sources of active oxygen-containing compounds.

B. Slow-Release Sub-Formulation

The slow-release sub-formulation includes one or more protease enzymes for cleaning proteinaceous stains in a formulation designed to delay the release of the majority of the protease enzymes into the wash liquor until the majority of the bleaching agent is released into the wash liquor. In some embodiments, less than about 50% of the protease is released into the wash liquor until a reaction between the bleaching agent and proteinaceous stains is complete.

In some embodiments, no more than about 50% of the protease is released into the wash liquor in less than about one minute until at least 80% of the bleaching agent is released into the wash liquor in less than about one minute, as measured at a specified, pre-selected temperature.

In some embodiments, the rate of dissolution of at least one delayed-release component is no more than 50% of the rate of dissolution of at least one fast-release component as measured at a specified, pre-selected temperature.

In some embodiments, the slow release sub-formulation can be described by its relative enzyme release profile, defined as the percentage of delayed release component relative to the percentage of fast-release component that is released into a wash liquor at any given time point in a wash cycle. In some embodiments, the relative enzyme release profile is from 10% to 90%, from 20% to 80%, or from 30% to 70%, as measured at a specified, pre-selected temperature.

Slow-release enzyme compositions of the present invention comprise at least one active protease enzyme for cleaning proteinaceous stains and optionally at least one non-protease enzyme selected from amylases, cellulases, lipases, mannanases, peroxidases, and or xylananses among others.

In some embodiments of the present invention, enzyme compositions comprise inactive ingredients selected from a group of materials that are known to the artisan for such functions as a carrier, a stabilizer, an antioxidant, a desiccant, an osmolality agent, a pH modifying agent, a surface-active agent, a dissolution aid, a dispersion aid, a lubricating aid, a pigment, a perfume, an anti-shrinkage agent, an anti-wrinkle agent, a germicide, a fungicide, and mixtures thereof.

In some embodiments, formulation design consists of both water soluble and water dispersible components (such as fatty acids, fatty acid salts, sugars, salts, glycols, and urea), and hydration or dissolution aids (such as sodium alginate, sodium docusate, sodium chloride, sodium sulfate, magnesium citrate and cellulosic polymers).

In some embodiments, slow-release compositions comprise a carrier ranging from about 25% to about 80% of the composition on a dry weight basis, and preferably about 35% to about 60%.

In one preferred embodiment, slow-release compositions comprise a carrier ranging from about 40% to about 50% of the composition on a dry weight basis.

In some embodiments, slow-release enzyme compositions comprise a meltable carrier with a melting point ranging from about 60° C. to about 150° C., and preferably from about 60° C. to about 120° C., and more preferably from about 60° C. to about 90° C.

In one preferred embodiment, slow-release enzyme compositions comprise a meltable carrier with a melting point of 65-75° C.

Numerous proteases have been included in detergent formulations. Examples of suitable proteases include but are not limited to subtilisins, such as those derived from Bacillus spp., including those described in, e.g., U.S. Pat. Nos. RE 34,606, 5,955,340, 5,700,676, 6,312,936, and 6,482,628, all of which are incorporated herein by reference. Additional proteases include trypsin (e.g., of porcine or bovine origin) and the Fusarium protease described in WO 89/06270. In some embodiments the protease is one or more of MAXATASE®, MAXACAL™, MAXAPEM™, OPTICLEAN®, OPTIMASE®, PROPERASE®, PURAFECT®, PURAFECT® OXP, PURAMAX™, EXCELLASE™, and PURAFAST™ (DuPont Industrial Biosciences); ALCALASE®, SAVINASE®, PRIMASE®, DURAZYM™, POLARZYME®, OVOZYME®, KANNASE®, LIQUANASE®, NEUTRASE®, RELASE® and ESPERASE® (Novozymes); BLAP™ and BLAP™ variants (Henkel Kommanditgesellschaft auf Aktien, Duesseldorf, Germany), and KAP (B. alkalophilus subtilisin; Kao Corp., Tokyo, Japan). Additional proteases are described in WO95/23221, WO 92/21760, WO 09/149200, WO 09/149144, WO 09/149145, WO 11/072099, WO 10/056640, WO 10/056653, WO 11/140364, WO 12/151534, U.S. Pat. Publ. No. 2008/0090747, and U.S. Pat. Nos. 5,801,039, 5,340,735, 5,500,364, 5,855,625, RE 34,606, 5,955,340, 5,700,676, 6,312,936, and 6,482,628.

Suitable proteases include neutral metalloproteases including those described in WO 07/044993 and WO 09/058661. Other exemplary metalloproteases include nprE, the recombinant form of neutral metalloprotease expressed in Bacillus subtilis (see e.g., WO 07/044993), and PMN, the purified neutral metalloprotease from Bacillus amyloliquefacients.

The same proteases, or different proteases, can be included in other sub-formulations in a detergent composition without departing from the intended scope of the compositions and methods. For example, the same or different proteases, can be included in a delayed release sub-formulation and additionally in a conventional, rapid release sub-formulation. However, the inclusion of proteases in this manner is unnecessary and, in some embodiments of the compositions and methods, proteases are only included in a slow release sub-formulation and in no other sub-formulations within the detergent composition. Accordingly, in particular embodiments, all proteases, a majority of proteases, substantially all proteases, or even essentially all proteases (except background proteases present in other enzyme preparations), are present in the slow-release sub-formulation.

### V. Additional Benefit Agents

The present formulation and methods may include a wide variety of additional benefit agents, in addition to proteases and oxidative bleaching agents.

A. Enzymes

Additional enzymes, which may be included in the fast-release sub-formulation, slow-release sub-formulation, both, or in other sub-formulations, include but are not limited to, acyl transferases, α-amylases, β-amylases, α-galactosidases, arabinosidases, aryl esterases, β-galactosidases, carrageenases, catalases, cellobiohydrolases, cellulases, chondroitinases, cutinases, endo-β-1, 4-glucanases, endo-beta-mannanases, esterases, exo-mannanases, galactanases, glucoamylases, hemicellulases, hyaluronidases, keratinases, laccases, lactases, ligninases, lipases, lipoxygenases, mannanases, oxidases, oxidoreductases, pectate lyases, pectin acetyl esterases, pectinases, pentosanases, perhydrolases, peroxidases, peroxygenases, phenoloxidases, phosphatases, phospholipases, phytases, polygalacturonases, pullulanases, reductases, rhamnogalacturonases, β-glucanases, tannases, transglutaminases, xylan acetyl-esterases, xylanases, xyloglucanases, xylosidases and even additional proteases. In some embodiments, no additional proteases are included and the majority of proteases, substantially all proteases, or even essentially all proteases (except background proteases present in other enzyme preparations), are present in the slow-release sub-formulation.

Suitable amylases include, but are not limited to those described in WO9510603, WO9526397, WO9623874, WO9623873, WO9741213, WO9919467, WO0060060, WO0029560, WO9923211, WO9946399, WO0060058, WO0060059, WO9942567, WO0114532, WO02092797, WO0166712, WO0188107, WO0196537, WO0210355, WO9402597, WO0231124, WO9943793, WO9943794, WO2004113551, WO2005001064, WO2005003311, WO0164852, WO2006063594, WO2006066594, WO2006066596, WO2006012899, WO2008092919, WO2008000825, WO2005018336, WO2005066338, WO2009140504, WO2005019443, WO2010091221, WO2010088447, WO0134784, WO2006012902, WO2006031554, WO2006136161, WO2008101894, WO2010059413, WO2011098531, WO2011080352, WO2011080353, WO2011080354, WO2011082425, WO2011082429, WO2011076123, WO2011087836, WO2011076897, WO94183314, WO9535382, WO9909183, WO9826078, WO9902702, WO9743424, WO9929876, WO9100353, WO9605295, WO9630481, WO9710342, WO2008088493, WO2009149419, WO2009061381, WO2009100102, WO2010104675, WO2010117511, WO2010115021, WO2013184577, WO9418314, WO2008112459, WO2013063460, WO10115028, WO2009061380, WO2009100102, WO2014099523, WO2015077126A1, WO2013184577, WO2014164777, PCT/US12/70334, PCT/US13/74282, PCT/CN2013/077294, PCT/CN2013/077134, PCT/CN2013/077137, PCT/CN2013/077142, PCT/CN2012/087135, PCT/US12/62209, PCT/CN2013/084808, PCT/CN2013/084809, and PCT/US14/23458. Commercially available amylases include, but are not limited to one or more of DURAMYL®, TERMAMYL®, FUNGAMYL®, STAINZYME®, STAINZYME PLUS®, STAINZYME ULTRA®, and BAN™ (Novozymes), as well as POWERASE™ RAPIDASE® and MAXAIVIYL® P, PREFERENZ® S100, PREFERENZ® S110, and PREFERENZ® S1000 (DuPont Industrial Biosciences).

Suitable lipases include, but are not limited to Humicola lanuginosa lipase (see e.g., EP 258 068 and EP 305 216), Rhizomucor miehei lipase (see e.g., EP 238 023), Candida lipase, such as C. antarctica lipase (e.g., the C. antarctica lipase A or B; see e.g., EP 214 761), Pseudomonas lipases such as P. alcaligenes lipase and P. pseudoalcaligenes lipase (see e.g., EP 218 272), P. cepacia lipase (see, e.g., EP 331 376), P. stutzeri lipase (see e.g., GB 1,372,034), P. fluorescens lipase, Bacillus lipase (e.g., B. subtilis lipase (Dartois et al. (1993) Biochem. Biophys. Acta 1131:253-260); B. stearothermophilus lipase (see, e.g., JP 64/744992); and B. pumilus lipase (see, e.g., WO 91/16422).

Additional suitable lipases include Penicillium camembertii lipase (Yamaguchi et al. (1991) Gene 103:61-67), Geotricum candidum lipase (see, Schimada et al. (1989) J. Biochem. 106:383-388), and various Rhizopus lipases such as R. delemar lipase (Hass et al. (1991) Gene 109:117-113), a R. niveus lipase (Kugimiya et al. (1992) Biosci. Biotech. Biochem. 56:716-719) and R. oryzae lipase. Additional lipases are the cutinase derived from Pseudomonas mendocina (see, WO 88/09367), and the cutinase derived from Fusarium solani pisi (WO 90/09446). Various lipases are described in WO 11/111143, WO 10/065455, WO 11/084412, WO 10/107560, WO 11/084417, WO 11/084599, WO 11/150157, and WO 13/033318. In some embodiments the protease is one or more of M1 LIPASE™, LUMA FAST™, and LIPOMAX™ (DuPont Industrial Biosciences); LIPEX®, LIPOLASE® and LIPOLASE® ULTRA (Novozymes); and LIPASE P™ “Amano” (Amano Pharmaceutical Co. Ltd., Japan).

Suitable cellulases include but are not limited to those having color care benefits (see e.g., EP 0 495 257). Examples include Humicola insolens cellulases (see e.g., U.S. Pat. No. 4,435,307) and commercially available cellulases such as CELLUZYME®, CAREZYME® (Novozymes), KAC-500(B)™ (Kao Corporation), and REVITALENZ® (DuPont Industrial Biosciences). In some embodiments, cellulases are incorporated as portions or fragments of mature wild-type or variant cellulases, wherein a portion of the N-terminus is deleted (see e.g., U.S. Pat. No. 5,874,276). Additional suitable cellulases include those found in WO2005054475, WO2005056787, U.S. Pat. Nos. 7,449,318, and 7,833,773.

Suitable mannanases are described in U.S. Pat. Nos. 6,566,114, 6,602,842, 5, 476, and 775, 6,440,991, and U.S. Patent Application No. 61/739,267, all of which are incorporated herein by reference). Commercially available include, but are not limited to MANNASTAR®, PURABRITE™, and MANNAWAY®.

Suitable peroxidases/oxidases include, but are not limited to those of plant, bacterial or fungal origin. Chemically or genetically modified mutants are included in some embodiments. Suitable perhydrolases include the enzyme from Mycobacterium smegmatis, described in detail in International Patent Application Publications WO 05/056782A and WO 08/063400A, and U.S. Patent Publications US2008145353 and US2007167344, and members of the carbohydrate family esterase family 7 (CE-7 family) described in, e.g., WO2007/070609 and U.S. Patent Application Publication Nos. 2008/0176299, 2008/176783, and 2009/0005590. Members of the CE-7 family include cephalosporin C deacetylases (CAHs; E.C. 3.1.1.41) and acetyl xylan esterases (AXEs; E.C. 3.1.1.72). Members of the CE-7 esterase family share a conserved signature motif (Vincent et al., J. Mol. Biol., 330:593-606 (2003)). Other suitable perhydrolase enzymes include those from Sinorhizobium meliloti, Mesorhizobium loti, Moraxella bovis, Agrobacterium tumefaciens, or Prosthecobacter dejongeii (WO2005056782), Pseudomonas mendocina (U.S. Pat. No. 5,389,536), or Pseudomonas putida (U.S. Pat. Nos. 5,030,240 and 5,108,457).

B. Other Benefit Agents

Other benefit agents, include but are not limited to, chelants, optical brighteners, soil release polymers, dye transfer agents, dispersants, suds suppressors, dyes, perfumes, colorants, filler salts, photoactivators, fluorescers, fabric conditioners, hydrolyzable surfactants, preservatives, anti-oxidants, anti-shrinkage agents, anti-wrinkle agents, germicides, fungicides, color speckles, silvercare, anti-tarnish and/or anti-corrosion agents, alkalinity sources, solubilizing agents, carriers, processing aids, pigments, and pH control agents, surfactants, builders, dye transfer inhibiting agents, deposition aids, catalytic materials, polymeric dispersing agents, clay soil removal/anti-redeposition agents, brighteners, structure elasticizing agents, fabric softeners, hydrotropes, processing aids and/or pigments. Suitable examples of such other adjuncts and levels of use are found in U.S. Pat. Nos. 5,576,282, 6,306,812, 6,326,348, 6,610,642, 6,605,458, 5,705,464, 5,710,115, 5,698,504, 5,695,679, 5,686,014 and 5,646,101 all of which are incorporated herein by reference. Representative detergent formulations useful for the present invention include the detergent formulations found in WO2013063460, WO2003010266, WO2006002755, WO2006088535, and US20110263475, all of which are hereby incorporated by reference.

### VII. Compositions Containing Delayed Release Sub-Formulations

The present compositions can be added to laundry and other cleaning formulations to be diluted into a substantially aqueous wash liquor. In general, the present compositions are a drop-in replacement for conventional granules and can be used to completely or partially replace conventional granules in virtually any form of detergent composition.

In some embodiments, the detergent composition is a liquid laundry detergent composition containing up to about 35% or less water, for example, from about 10% to about 25% water volume/volume (vol/vol). Examples of low water detergent compositions are concentrated heavy duty liquid (HDL) laundry detergents, such as ALL® Small & Mighty Triple Concentrated Liquid Laundry Detergent (Sun Products Corp.), ARM & HAMMER® 2× Concentrated Liquid Laundry Detergent (Church & Dwight), PUREX® concentrate Liquid Laundry Detergent (Henkel), TIDE® 2× Ultra Concentrated Liquid Laundry Detergent (Procter & Gamble), and the like.

In some embodiments, the detergent composition is a low-water liquid laundry detergent composition containing up to about 10% or less water, for example, from about 1% to about 10% water (vol/vol). Examples of low-water detergent compositions are found in PUREX® UltraPacks (Henkel), FINISH® Quantum (Reckitt Benckiser), CLOROX™ 2 Packs (Clorox), OXICLEAN MAX FORCE POWER PAKS™ (Church & Dwight), and TIDE® Stain Release, CASCADE® ActionPacs, and TIDE® PODS™ (Procter & Gamble). Preferred very low-water detergent compositions do not dissolve the water-soluble material used in the unit dose packages described, herein.

In some embodiments, the detergent composition is a dry powder, a tablet, a bar, or a gel.

### VII. Methods of Use

The present delayed release formulations can be used in cleaning applications where optimized oxidative bleaching activity and protease activity is desired, and the attachment of polypeptides to an article to be cleaned is to be avoided. Such applications include manual and automatic laundry washing, dish washing, and other hard surface cleaning.

The following examples are intended to illustrate, but not limit, the present compositions and methods.

### EXAMPLES

### Example 1. Materials and Methods

The following reagents and equipment were used in the Examples.
100 mM Tris/HCl buffer, pH 8.6 with 0.005% Tween-80
N-succinyl-L-Ala-L-Ala-L-Pro-L-Phe-p-nitroanilide (AAPP; Sigma, S-7388); 100 mg/mL stock solution in DMSO and 160 mM working solution in Tris/HCl buffer
Fabric swatches (Materials Research Products) including: EMPA 116 (blood/milk/ink (“BMI”) on cotton); EMPA 117 (blood/milk/ink (“BMI”) on polyester/cotton, 65/35); CFT AS-10 (pigment/oil/milk (“POM”) on cotton); and plain cotton swatch (no stain)
Microplate Gang Puncher, Model 510 (Engineering by Design)
ECE-2 Standard Detergent (wfk Testgewebe GmbH)
ECE-2 Standard Detergent with bleach (i.e., TAED and sodium percarbonate) (wfk Testgewebe GmbH)
Water hardness (3:1 CaCl₂), MgCl₂)=256,000 mg/L Ca²⁺
Corning 15 or 50 mL centrifuge tubes, polypropylene (Sigma Aldrich)
Rotamix RKVS Laboratory Shaker
Millipore™ STERIFLIP® 50 mL filter units with Express® Plus Membrane (0.22 μm)
Whatman 0.45 μM syringe filter with 5 mL syringe
Corning 3641 96-well clear flat bottom polystyrene nonbinding-surface microplate
LIQUIDATOR™ 96 Manual Pipetting System (Mettler)
VWR aluminum foils for 96-well plates
Eppendorf THERMOMIXER™ R with microplate block (Thermo Fisher Scientific)
SpectraMax 340 Microplate Reader (Molecular Devices)

The following methods were used in the Examples.

### Detergent Preparation:

80 mg of detergent or detergent with the bleach system was added to two separate 50 mL tubes. 40 mL of 100 mM Tris/HCl buffer, pH 8.6, was added to each tube. The water hardness solution was diluted 5-fold, then 116.8 μL was added to each 50 mL tube to make a concentration of 150 ug/mL. The addition of water hardness to deionized (DI) water makes it more representative of tap water. Each 50-mL tube containing detergent, with or without bleach, was mixed end-over-end for 30 minutes, then the contents were filtered using a 0.22 μm filter.

### AAPF Substrate Preparation:

500 μL of AAPF stock solution was added to a 50-mL tube and the volume brought up to 50 mL with 100 mM Tris/HCl buffer, pH 8.6.

### Enzyme Stock Solutions:

16.8 μL of purified enzyme (e.g., PROPERASE®; Danisco US Inc.) at a concentration of 32.6 mg/mL was diluted in 5 mL Tris/HCl buffer to make 200 μg/mL starting solution (i.e., a 163× dilution). 2× serial dilutions were made to produce 200, 100, 50, 25, 12.5, 6.25, and 3.125 μg/mL working dilutions.

### Enzyme Activity Assays:

190 μL of the filtered detergent preparation was added to each well of reaction plate “A.” 190 μL of the filtered detergent plus bleach preparation was added to each well of reaction plate “B.” 10 μL of each of the enzyme working dilutions were added to sequential columns of each plate with the amount of enzyme titrated from high to low concentration.

The plates were sealed and placed in a mixer for 13 minutes at 32° C. at 650 rpm. 190 μL of the suc-AAPF-pNA (N-succinyl-L-Ala-L-Ala-L-Pro-L-Phe-p-nitroanilide) substrate was added to each well of two additional 96-well plates (i.e., plate “C” for the detergent preparation and plate “D” for the detergent plus bleach preparation). 10 μL of the supernatant from each reaction plate was transferred to the corresponding well plates containing AAPF substrate. Each plate was placed in a spectrophotometer set for a kinetic reading every 12 seconds at 405 nm to measure supernatant activity.

### Micro-Swatch Assay:

Swatches were punched into 96-well plates and rinsed to remove loosely bound stain using three 1-hour rinses of 200 μL distilled deionized water. Different swatches were arranged in columns in a first plate “A” to be incubated with detergent alone and a second plate “B” to be incubated with detergent plus a percarbonate/tetraacetylethylenediamine (TAED) bleach system, such that eight swatches of the same type were assayed in each plate. One column of each plate was used for the enzyme control (i.e., no swatch). The microswatch assay was used to generate the data shown in Tables 1-6.

### Enzyme Binding Calculations:

The percentage of the enzyme bound to each swatch was calculated by dividing the activity of the supernatants in the wells with swatch present by the activity of the enzyme control in the wells in which no swatch was present for both the detergent and detergent plus bleach preparations.

### Terg-o-Tometer Wash Assay:

1 liter of deionized water was added to each Terg-o-tometer pot. 0.584 mL of 15,000 gpg 3:1 Ca:Mg water hardness stock was then added to each pot, and the pots were mixed for 3 minutes at 100 rpm until the water reached the desired wash temperature of 90° F., or 32° C. In the case where stain removal was also assessed in addition to dissolution performance, 30 grams of ballast was added per liter of wash liquor (see below). 2 grams of the ECE-2 HDD detergent, either with or without bleach (sodium percarbonate+TAED), was added per liter of water in each pot immediately prior to enzyme addition. Enzyme granules were then added by weight into each pot, so that the concentration of protease was 10 ppm in 1 liter of wash liquor. The pots were then mixed for 15 minutes at 100 rpm and 32° C. 5 mL aliquots were removed at 0:30, 1:00, 1:30, 2, 3, 4, 5, 7, 9, 11, 13, and 15 min during the wash cycle and filtered into the 15 mL tubes using 0.45 μM syringe filters. Samples were then diluted 4-fold in 100 mM Tris/HCl buffer, pH 8.6 with 0.005% Tween-80 and assayed for residual activity using the AAPF assay on the Konelab.

Where ballast was added, 30 grams of ballast was prepared as follows: EMPA 116 (blood, milk, ink stain on cotton ballast), EMPA 117 (blood, milk, ink stain on polycotton ballast), and CFT C-10 (pigment, oil, milk stain on cotton ballast) were weighed out such that each different stained swatch was separated by unstained white cotton ballast, and each 30 grams of ballast contained duplicate of each different stained swatch.

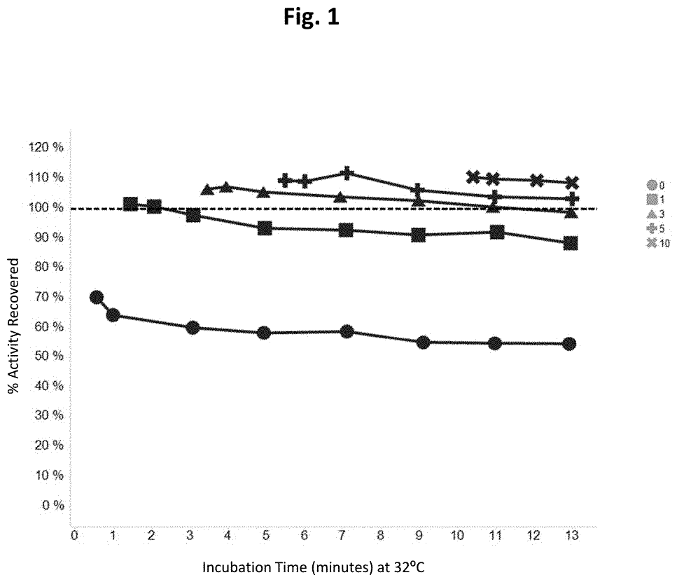

At the end of the wash cycle, ballast was transferred to a 4-liter beaker and rinsed under cold running tap water for 3 minutes. The white cotton ballast was discarded. The rinsed swatches were then placed in a front-loading washing machine, which was set to run on a spin cycle at 1000 rpm for 7 minutes. The ballast was then dried in the drying machine, set on low heat and automatic dry. A Minolta Reflectometer, 50 mm aperture, was then used to read the center of the stain in duplicate on the dried swatches on top of a black background. The Terg-o-tometer assay was used to generate the data shown in FIGS. 1-4.

### Active Oxygen Measurement:

To measure bleach activity, the amount of active oxygen in a wash liquor can be measured using ASTM method D2180-17 “Standard Test Method for Active Oxygen in Bleaching Compounds” (ASTM International, West Conshohocken, Pa., USA).

### Example 2. Effect of Delayed Addition of Protease in the Presence of Oxidative Bleaching Agents on Enzyme Activity in the Wash

To determine whether the time of enzyme addition to a wash liquor containing a detergent plus bleach preparation affects the residual activity of the enzyme in the liquor, 1.5 ppm commercially-available laundry protease (i.e., liquid purified PROPERASE®, 46.4 mg/mL (Danisco US Inc.)) was added 0, 1, 3, 5 or 10 minutes after mixing a standard heavy duty dry (HDD) detergent plus bleach preparation (i.e., ECE-2) with water at 32° C., no ballast. The residual amount of protease activity in the wash liquor over time was then determined and compared to the initial amount of protease introduced, as described in Example 1.

As shown in FIG. 1, delayed addition of the protease as a liquid bolus (i.e., a single addition) resulted in a sustained higher residual activity throughout the course of the experiment. When the protease was added immediately following dissolution of the detergent plus bleach preparation, residual protease activity quickly diminished by over 30%. Even waiting as little as about one minute to add the protease as a bolus resulted in a substantial increase in residual activity, suggesting that inactivation of the protease occurs in a rapid reaction that takes place in freshly diluted bleach-containing wash liquor.

In wash liquor containing a non-bleach detergent and/or in wash liquor not containing ballast, residual protease activity is not dependent on the time of addition following initial preparation of the detergent wash liquor (data not shown).

### Example 3. Mechanism for Protease Inactivation by Oxidative Bleaching Agent

Further using the materials and methods described in Example 1, protease activity was measured following incubation in detergent with or without bleach and in the presence of stained or unstained swatches. The results are summarized in Tables 1 and 2.

The presence of bleach in the absence of swatches impacted the performance of the protease, as evidenced by the reduced activity values in the “No fabric”-column in Table 2 compared to Table 1. The presence of unsoiled cotton fabric made only a slight difference to the activity of protease in solution. Most notably, a marked reduction of protease activity was observed in the presence of bleach and soiled fabric, suggesting that bleach causes the protease to become immobilized on the stained swatch.

TABLE 1
Residual activity (%) of PROPERASE ® in detergent preparations

| | | | Cotton fabric | Cotton fabric | |
|---|---|---|---|---|---|
| Enzyme | | Cotton | soiled with | soiled with | Polyester/cotton |
| Dose | No | fabric | pigment/ | blood/milk/ | fabric soiled with |
| (μg/mL) | fabric | unsoiled | oil/milk | ink | blood/milk/ink |
| 5.00 | 100 | 91 | 94 | 88 | 85 |
| 2.50 | 100 | 96 | 92 | 91 | 92 |
| 1.25 | 100 | 97 | 93 | 89 | 91 |
| 0.63 | 100 | 97 | 92 | 94 | 89 |
| 0.31 | 100 | 97 | 92 | 85 | 86 |
| 0.16 | 100 | 98 | 92 | 75 | 79 |

TABLE 2
Residual activity (%) of PROPERASE ® in detergent plus bleach
preparations

| | | | Cotton fabric | Cotton fabric | |
|---|---|---|---|---|---|
| Enzyme | | Cotton | soiled with | soiled with | Polyester/cotton |
| Dose | No | fabric | pigment/ | blood/ | fabric soiled with |
| (μg/mL) | fabric | unsoiled | oil/milk | milk/ink | blood/milk/ink |
| 5.00 | 81 | 79 | 67 | 53 | 53 |
| 2.50 | 83 | 79 | 70 | 53 | 55 |
| 1.25 | 85 | 81 | 74 | 52 | 55 |
| 0.63 | 85 | 80 | 71 | 44 | 50 |
| 0.31 | 84 | 79 | 71 | 43 | 51 |
| 0.16 | 87 | 81 | 74 | 39 | 43 |

From the decrease in soluble protease activity observed in the data summarized in Tables 1 and 2, the amount of protease bound or immobilized on the stained and unstained swatches was calculated. The results are summarized in Tables 3 and 4 for detergent compositions and detergent plus bleach compositions, respectively. The presence of bleach roughly doubled the amount of protease activity that was unaccounted for in solution and presumed to be bound or immobilized to the soiled swatches.

TABLE 3
Amount (%) of PROPERASE ® bound to swatches in detergent

| Enzyme | Cotton | Cotton fabric | Cotton fabric | Polyester/cotton |
|---|---|---|---|---|
| Dose | fabric | soiled with | soiled with | fabric soiled with |
| (μg/mL) | unsoiled | pigment/oil/milk | blood/milk/ink | blood/milk/ink |
| 5.00 | 9 | 6 | 12 | 15 |
| 2.50 | 4 | 8 | 9 | 8 |
| 1.25 | 3 | 7 | 11 | 9 |
| 0.63 | 3 | 8 | 16 | 11 |
| 0.31 | 3 | 8 | 15 | 14 |
| 0.16 | 2 | 8 | 25 | 21 |

TABLE 4
Amount (%) of PROPERASE ® bound to swatches in detergent
plus bleach

| Enzyme | Cotton | Cotton fabric | Cotton fabric | Polyester/cotton |
|---|---|---|---|---|
| Dose | fabric | soiled with | soiled with | fabric soiled with |
| (μg/mL) | unsoiled | pigment/oil/milk | blood/milk/ink | blood/milk/ink |
| 5.00 | 2 | 14 | 28 | 28 |
| 2.50 | 5 | 13 | 30 | 28 |
| 1.25 | 4 | 12 | 33 | 30 |
| 0.63 | 5 | 13 | 41 | 35 |
| 0.31 | 5 | 14 | 42 | 33 |
| 0.16 | 6 | 13 | 48 | 44 |

To determine whether the observed binding of protease to soiled fabrics was generalizable to other proteases or specific to PROPERASE® (a variant of Bacillus lentus subtilisin), the experiments were separately repeated with two other subtilisin variants. The results are shown in Table 5 and 6 where “X”=PROPERASE®, “Y”=Bacillus lentus GG36 subtilisin, and “Z”=GG145 (a variant of GG36).

TABLE 5
Binding of three different proteases to swatches in the presence
of detergent

| | Percentage Bound | | |
|---|---|---|---|
| | to Blood/ | | |
| Detergent | Milk/Ink Stain | | |
| Enzyme Dose (μg/mL) | “X” | “Y” | “Z” |
| 5.00 | 12 | 38 | 9 |
| 2.50 | 9 | 43 | 10 |
| 1.25 | 11 | 42 | 8 |
| 0.63 | 16 | 44 | 16 |
| 0.31 | 15 | 45 | 26 |
| 0.16 | 25 | 50 | 38 |

TABLE 6
Binding of three proteases to swatches in the presence of detergent
with bleach

| | Percentage Bound | | |
|---|---|---|---|
| | to Blood/ | | |
| Detergent/Bleach | Milk/Ink Stain | | |
| Enzyme Dose (μg/mL) | “X” | “Y” | “Z” |
| 5.00 | 28 | 77 | 52 |
| 2.50 | 30 | 79 | 55 |
| 1.25 | 33 | 84 | 58 |
| 0.63 | 40 | 83 | 64 |
| 0.31 | 42 | 84 | 69 |
| 0.16 | 48 | 84 | 73 |

The results show that all three proteases became bound or immobilized on soiled swatches in the presence of bleach, indicating that the observations are generalizable to proteases and protein-based soils.

### Example 4. Delayed Release Formulations

The foregoing examples suggest that a detergent formulation that would allow for the immediate release of bleach (including multiple component of a bleaching system) but the delayed release of protease would result in increased residual protease activity for the duration of a wash cycle. Such a formulation could include sub-formulations, for example, a fast-release sub-formulation containing bleach and a slow-release sub-formulation containing protease.

Fast release detergent formulations are widely in use in commercially available detergent products, including those with bleach. To test the ability to make practical and cost effective delayed release formulations, the prototypes summarized in Table 7 were prepared, where the weight/weight percent (wt/wt %) of components is specified. The enzyme used was PROPERASE®.

Slow-release enzyme granules were produced by using a spinning disk atomizer in a laboratory setup. Meltable carrier compositions B and C, as defined in Table 7, were heated and maintained at least 20-25° C. above their melting points. Inactive ingredients followed by active enzyme powder were dispersed in each molten carrier under continuous stirring and were homogenized into a uniform composition within less than 2 minutes. Fine droplets were formed by dispensing the molten composition onto a heated stainless steel spinning disk (10 cm dia., 1550 rpm) installed in a reaction chamber at normal ambient temperature. The disk was heated and set 20-25o° C. above the congealing point of the meltable carrier. Fine melt droplets formed by atomization solidified into particles at room temperature and collected on the chamber floor.

TABLE 7
Prototype delayed release formulations

| Formu- | Stearic | Potassium | Sodium | Sodium | | Spray Dried |
|---|---|---|---|---|---|---|
| lation | acid | oleate | stearate | alginate | Talc | Enzyme |
| B | 64 | 0 | 28 | 0 | 5 | 3 |
| C | 45 | 25 | 0 | 20 | 4 | 6 |

By adjusting the ratio of formulation components, release profiles that would enable the described compositions and methods to be put into practice were demonstrated. Release testing of the formulations shown in Table 7 were performed in wash liquor made using ECE-2 detergent without bleach and without ballast at 32° C. with 150 ppm 3:1 Ca:Mg water hardness, as above. Since the goal of the release testing was only to determine the release profile of the prototypes, the presence of bleach and ballast was not required.

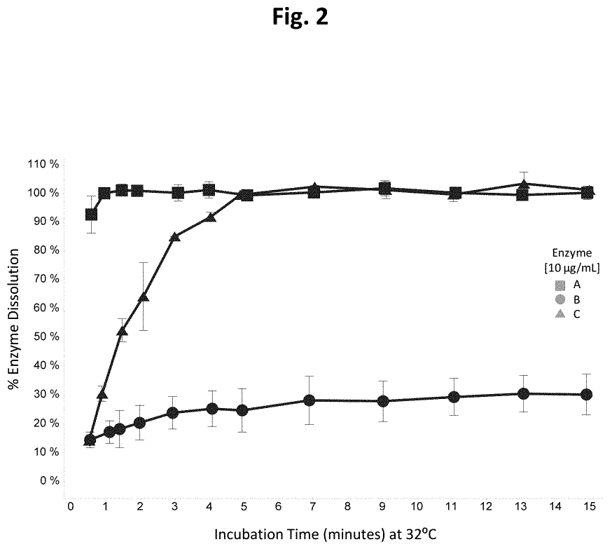

The results of the release testing are shown in FIG. 2. A commercially-available PROPERASE® granule (hereinafter., Formulation A), which represents a conventional fast-release granule, results in the release of essentially 100% of the enzyme within about one minute. Such a granule is not compatible with the present compositions and methods since much of the enzyme activity would be lost in the presence of bleach. The prototype formulation B granule has a much slower release profile, to the extent that only about 30% of enzyme activity is observed even after 15 minutes. Such a granule is also not compatible with the present compositions and methods since much of the enzyme activity is trapped in the formulation and not available for cleaning.

The prototype formulation C granule exemplifies a formulation with a release profile that is suited to the present compositions and methods. The release of protease is essentially complete within five minutes while only about 20% of the protease is released in the first minute. This release profile indicates that the majority of the enzyme will avoid sequestration/inactivation by the initial bleach/soiled ballast conditions. It will be appreciated that the release profile can be further optimized as needed by formulation adjustments. This experiment demonstrates the ability to design and produce cost-effective, slow-release formulations that enable the present compositions and methods to be put into practice.

### Example 5. Stain Removal Performance of Delayed Release Formulations

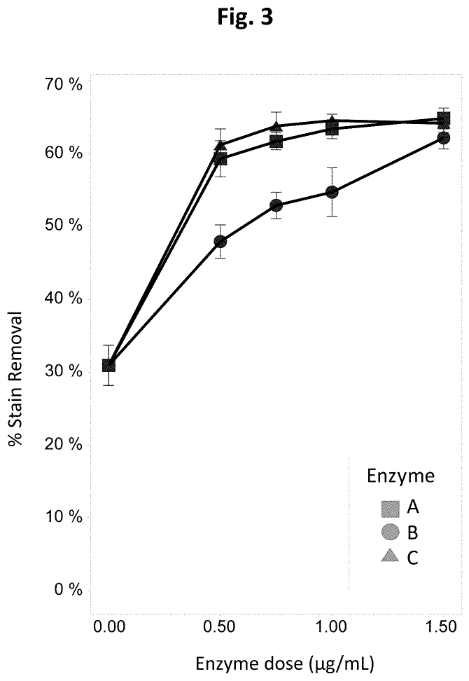

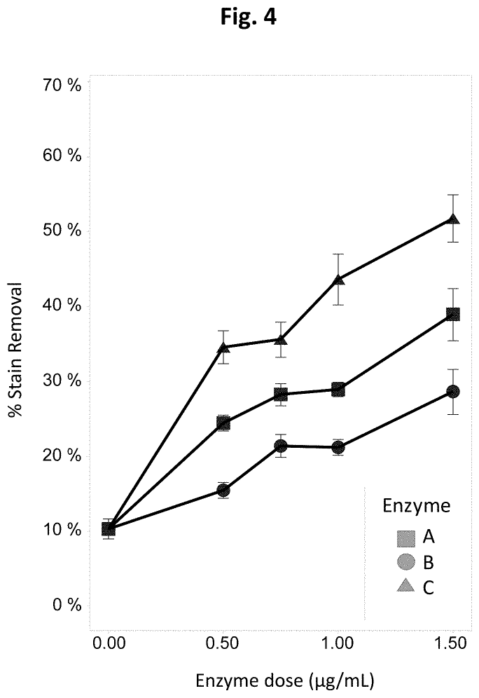

Stain removal performance of the delayed release formulations from Example 4 on EMPA 117 (blood, milk, ink stain on polycotton) swatches at 32° C. was determined using the Terg-o-tometer assay. Formulations A, B or C were added to wash liquor containing ECE-2 HDD detergent without bleach (FIG. 3) or ECE-2 HDD detergent with bleach (FIG. 4). In the detergent without bleach, Formulations A and C exhibited similar cleaning performance. Formulation B exhibited reduced cleaning performance as a result of incomplete enzyme release. In the detergent with bleach, Formulation C exhibited superior cleaning performance compared to Formulation A because of its delayed release characteristics. As before, Formulation B exhibited reduced cleaning performance as a result of incomplete enzyme release.

All references cited herein are hereby incorporated by reference.

What is claimed is:

1. A cleaning composition for removing proteinaceous stains from surfaces in the presence of a bleaching agent, comprising:
a first sub-composition comprising a bleaching agent and being capable of rapid dissolution in a wash liquor; and
a second sub-composition comprising a protease and having a slower rate of dissolution in the wash liquor compared to the first sub-composition comprising the bleaching agent;
wherein upon dilution in a wash liquor at a preselected temperature, the majority of the bleaching agent is released into the wash liquor before the majority of the protease is released into the wash liquor.

2. The cleaning composition of claim 1, wherein less than about 50% of the protease is released into the wash liquor until a bleaching reaction between the bleaching agent and proteinaceous stains is complete.

3. The cleaning composition of claim 1 or 2, wherein at least 80% of the bleaching agent is released into the wash liquor in less than about one minute before no more than about 50% of the protease is released into the wash liquor in less than about one minute, as measured at a pre-selected temperature.

4. The cleaning composition of claim 3, wherein the preselected temperature is 32° C.

5. The cleaning composition of claim 3, wherein the preselected temperature is 16° C.

6. The cleaning composition of any of the previous claims, wherein the cleaning composition is a laundry detergent.

7. The cleaning composition of any of the previous claims, wherein the surface having the proteinaceous stains to be cleaned is a fabric.

8. The cleaning composition of any of the previous claims, wherein the protease is a subtilisin protease.

9. A method of cleaning proteinaceous stains in the presence of a bleaching agent, the method comprising:
providing a cleaning composition comprising:
a first sub-composition comprising a bleaching agent and being capable of rapid dissolution in a wash liquor; and
a second sub-composition comprising a protease and having a slower rate of dissolution in the wash liquor compared to the sub-composition comprising the bleaching agent;
adding the cleaning composition to a wash liquor in contact with an article having a proteinaceous stain to clean the proteinaceous stain; and
incubating the article having a proteinaceous stain with the cleaning composition in the wash liquor for a time sufficient to affect the dissolution of the first and second sub-compositions;
wherein the cleaning of the proteinaceous stains is improved compared to providing the bleaching agent and the protease in the same sub-composition.

10. The method of claim 9, wherein less than about 50% of the protease is released into the wash liquor until a bleaching reaction between the bleaching agent and proteinaceous stains is complete.

11. The method of claim 9 or 10, wherein at least 80% of the bleaching agent is released into the wash liquor in less than about one minute before no more than about 50% of the protease is released into the wash liquor in less than about one minute, as measured at a pre-selected temperature.

12. The method of claim 11, wherein the preselected temperature is 32° C.

13. The method of claim 11, wherein the preselected temperature is 16° C.

14. The method of any of claims 9-13, wherein the cleaning composition is a laundry detergent.

15. The method of any of claims 9-14, wherein the surface having the proteinaceous stains to be cleaned is a fabric.

16. The method of any of claims 9-15, wherein the protease is a subtilisin protease.

17. A method for reducing the amount of protease enzyme required to at least partially remove proteinaceous stains from fabric in the presence of a bleaching agent, the method comprising providing the protease in a first composition having a slower rate of dissolution in the wash liquor compared to a second composition comprising the bleaching agent, wherein the cleaning of the proteinaceous stains is improved compared to providing the bleaching agent and the protease in the same composition.

18. The method of claim 17, wherein less than about 50% of the protease is released into the wash liquor until a reaction between the bleaching agent and proteinaceous stains is complete.

19. The method of claim 17 or 18, wherein at least 80% of the bleaching agent is released into the wash liquor in less than about one minute before no more than about 50% of the protease is released into the wash liquor in less than about one minute, as measured at a pre-selected temperature.

20. The method of claim 19, wherein the preselected temperature is 32° C.

21. The method of claim 19, wherein the preselected temperature is 16° C.

22. The method of any of claims 17-21, wherein the composition is a laundry detergent.

23. The method of any of claims 17-22, wherein the protease is a subtilisin protease.

24. The method of any of claims 17-23, wherein the reduction in the amount of protease enzyme required to at least partially remove proteinaceous stains from the fabric is at least 25%.
